(19) United States
(12) Patent Application Publication
(10) Pub. No.: US 2012/0248998 A1
(43) Pub. Date: Oct. 4, 2012

(54) LED DRIVER AND LED ILLUMINATOR HAVING THE SAME

(75) Inventor: Mitsutomo YOSHINAGA, Niiza-shi (JP)

(73) Assignee: Sanken Electric Co., Ltd., Niiza-shi (JP)

(21) Appl. No.: 13/432,367

(22) Filed: Mar. 28, 2012

(30) Foreign Application Priority Data
Mar. 30, 2011 (JP) 2011-076139
Dec. 28, 2011 (JP) 2011-287910

(51) Int. Cl. H05B 37/00

(52) U.S. Cl. 315/193

(57) ABSTRACT

An LED driver includes a power converter that includes a transformer having primary and secondary windings and a switching element connected to the primary winding and supplies power through the primary winding to an LED load, a feedback unit that is connected to the secondary winding and includes a control information detector to detect control information related to ON/OFF control of the switching element and a voltage detector to detect winding voltage information related to a voltage of the secondary winding, and a controller that carries out the ON/OFF control of the switching element. The feedback unit generates a feedback signal by superposing the control information onto the winding voltage information. The controller carries out the ON/OFF control of the switching element according to the feedback signal.

### BACKGROUND OF THE INVENTION

1. Field of the Invention

The present invention relates to an LED driving apparatus for driving an LED light source having LEDs (light emitting diodes) and an LED illumination apparatus employing the LED driving apparatus.

2. Description of Related Art

Indoor and outdoor illumination apparatuses have used filament bulbs or fluorescent lamps as light sources. Since white LEDs have been developed and their brightness and efficiency have been improved in recent years, the white LEDs are practically used as light sources of many illumination apparatuses. The white LED emits white light by mixing light of R (red), G (green), and B (blue) LED elements or by combining a short-wavelength LED such as a blue-light LED with a phosphor.

The LED illuminator employs an LED driver for supplying a driving current to the LEDs. The LED driver is a switching regulator as a DC-DC converter. Each LED has nonlinear I-V (current-voltage) characteristics. If a forward bias voltage applied to the LED is lower than a predetermined value VF, the LED substantially allows no current, and therefore, emits no light. If the forward bias voltage exceeds the predetermined value VF, the LED allows passing of a current that sharply increases in response to an increase in the forward bias voltage and the LED emits light in proportion to the amount of the current. The VF characteristic of an LED generally involves a variation of the VF of about plus-minus 10% and varies due to heat that is generated when a current passes through the LED passes to emit light. These individual difference and variation in the VF characteristic of each LED cause the LED illuminator to flicker.

The LED driver of the LED illuminator is required to drive the LEDs so that they stably emit light at a predetermined brightness without regard to the individual difference and variation in the VF characteristic of each LED. According to JEL801 for general illumination of Japan Electric Lamp Manufacturers Association, the LED driver must control a variation in LED current within plus-minus 10% of a predetermined value. To achieve this, the LED driver should have a constant current controlling feedback loop that keeps a constant current passing through the LEDs.

Consumer products that are easily accessible by person must have safety measures to prevent electric shock. For this, the LED driver is needed to include a transformer that electrically isolates a commercial power source from load, i.e., the LEDs.

FIG. 1 illustrates an LED driver according to a related art disclosed in Japanese Unexamined Patent Application Publication No. 2010-092997. The LED driver of this related art is an insulated switching power source and is generally called a flyback converter. In FIG. 1, the LED driver 201 and an LED load 202 form an LED illuminator 300. The LED driver 201 includes an input capacitor 211, a transformer 212, a MOSFET 213, and a driver 219. Also included in the LED driver 201 are an error amplifier 215, a diode 216, and a photocoupler 217.

The error amplifier 215 performs a predetermined operation according to a voltage generated by a current detection resistor 218 and a voltage provided by a reference voltage source and feeds back an operation result through the photocoupler 217 to the driver 219, thereby the LED driver 201 controls and keeps a constant current passing through the LED load 202.

### SUMMARY OF THE INVENTION

The LED driver 201 of the related art controls the MOSFET 213 according to a current passing through the LED load 202, and therefore, it must employ the photocoupler 217 to transmit a signal prepared according to an LED current detected on the secondary side of the transformer 212 to the driver 219 that is located on the primary side of the transformer 212. The photocoupler 217 needs peripheral elements to drive the same, such as the error amplifier 215 and the power source for the error amplifier 215. This configuration increases the size and cost of the LED driver 201 and LED illuminator 300.

The present invention provides an LED driver capable of supplying a constant current to an LED load and manufacturable to be compact at low cost and an LED illuminator employing the LED driver.

According to an aspect of the present invention, the LED driver includes a power converter that includes a transformer having a primary winding and a secondary winding and a switching element connected to the primary winding and supplies power through the primary winding to an LED load, a feedback unit that is connected to the secondary winding and includes a control information detector to detect control information related to ON/OFF control of the switching element and a voltage detector to detect winding voltage information related to a voltage of the secondary winding, and a controller that carries out the ON/OFF control of the switching element. The feedback unit generates a feedback signal by superposing the control information onto the winding voltage information. The control unit carries out the ON/OFF control of the switching element according to the feedback signal.

According to another aspect of the present invention, the LED illuminator includes the LED driver and an LED load including at least one LED.

### BRIEF DESCRIPTION OF THE DRAWINGS

FIG. 1 is a circuit diagram illustrating an LED driver and LED illuminator according to a related art;

FIG. 2 is a circuit diagram illustrating an LED driver and LED illuminator according to a first embodiment of the present invention;

FIG. 3 is a graph illustrating VF-ILED (forward voltage-LED current) characteristic curves of the first embodiment, related art, and first and second reference examples;

FIG. 4 is a circuit diagram illustrating an LED driver and LED illuminator according to the first reference example;

FIG. 5 is a circuit diagram illustrating an LED driver and LED illuminator according to the second reference example;

FIG. 6 is a circuit diagram illustrating an LED driver and LED illuminator according to a second embodiment of the present invention;

FIG. 7 is a graph illustrating VF-ILED characteristic curves of the second and first embodiments;

FIG. 8 is a circuit diagram illustrating an LED driver and LED illuminator according to a third embodiment of the present invention;

FIG. 9 is a circuit diagram illustrating an LED driver and LED illuminator according to a fourth embodiment of the present invention;

FIG. 10 is a graph illustrating Vin-ILED (AC input voltage-LED current) characteristic curves of the fourth embodiment;

FIG. 11 is a circuit diagram illustrating an LED driver and LED illuminator according to a fifth embodiment of the present invention; and

FIG. 12 is a circuit diagram illustrating an LED driver and LED illuminator according to a sixth embodiment of the present invention.

### DESCRIPTION OF PREFERRED EMBODIMENTS

Embodiments of the present invention will be explained in detail with reference to the drawings. In the drawings, the same or like parts are represented with the same or like reference marks. The embodiments mentioned below are only examples of technical ideas of the present invention and are modifiable in various ways within the scope of the present invention stipulated in the claims.

### First Embodiment

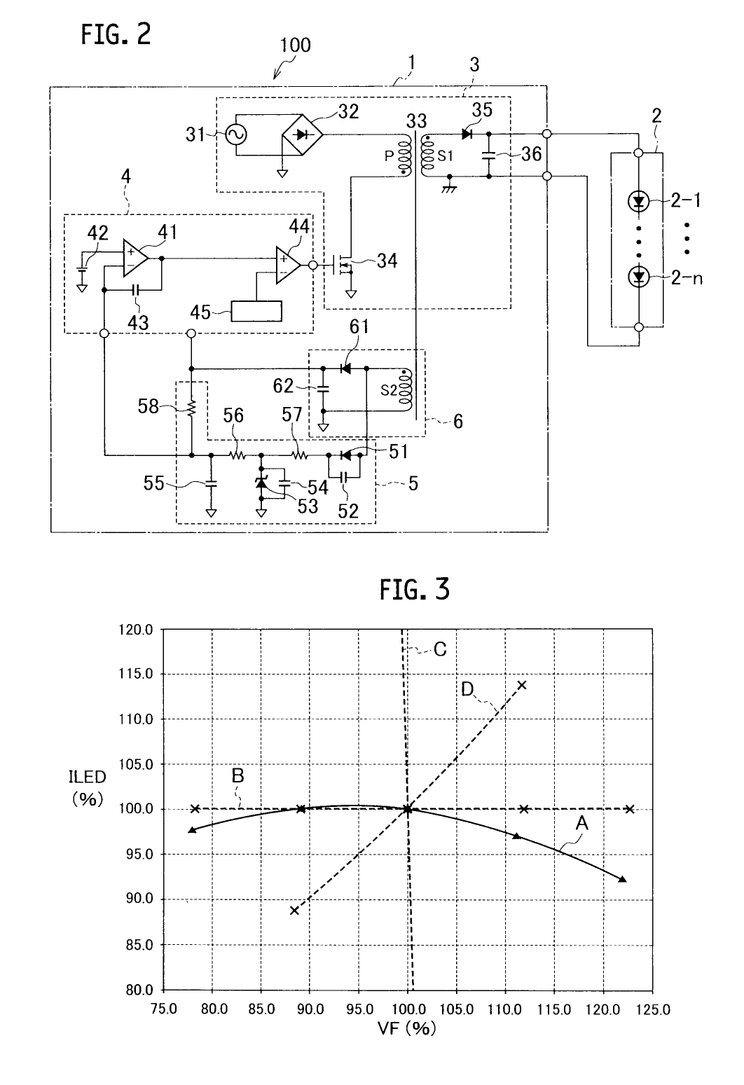

FIG. 2 is a circuit diagram illustrating an LED driver and LED illuminator according to the first embodiment of the present invention. The LED illuminator 100 includes the LED driver 1 and an LED load 2 connected to the LED driver 1.

The LED driver 1 is a DC-DC converter employing an insulated switching regulator. The LED driver 1 receives input power from an AC power source such as a commercial power source or from a DC power source such as a battery, converts the input power into required DC power, and outputs the required DC power to the LED load 2. The LED driver 1 includes an insulated power converter 3 connected to the LED load 2, a controller 4 connected to the power converter 3, and a feedback part 5 connected to the power converter 3 and controller 4. The LED driver 1 also includes a control power source 6 that is part of the power converter 3 and is connected to the controller 4 and feedback part 5.

The LED load 2 is a DC light emitting load that emits light with the DC power supplied from the LED driver 1. The LED load 2 includes at least one white LED that is made of R (red), G (green), and B (blue) LED elements or a short-wavelength LED. According to the first embodiment, the LED load 2 includes n white LEDs 2-1 to 2-n that are connected in series.

The power converter 3 is a known flyback converter including a transformer 33. The power converter 3 converts input power into required DC power and supplies the required DC power through the transformer 33 to the LED load 2. The power converter 3 includes the transformer 33 having a primary winding P, a secondary winding S1, and a tertiary winding S2, a switching element 34 connected to the primary winding P, the AC power source 31, a diode bridge 32, and a rectifying-smoothing circuit including an output diode 35 and an output capacitor 36. In FIG. 2, a black dot depicted at each of the windings P, S1, and S2 represents a polarity of the winding.

Both ends of the AC power source 31 are connected to first and second terminals of the diode bridge 32, respectively. A third terminal of the diode bridge 32 is connected to a first end of the primary winding P of the transformer 33 and a fourth terminal of the diode bridge 32 is connected to a primary-side ground. A second end of the primary winding P is connected to a first end (drain) of the switching element 34. The switching element 34 is, for example, a MOSFET (metal-oxide-semiconductor field-effect transistor). A second end (source) of the switching element 34 is connected to the primary-side ground and a control terminal (gate) of the switching element 34 is connected to the controller 4.

The secondary winding 51 of the transformer 33 is wound around a core in opposite polarity with respect to the polarity of the primary winding P. A first end of the secondary winding S1 is connected to an anode of the output diode 35 and a second end of the secondary winding S1 is connected to a secondary-side ground. A cathode of the output diode 35 is connected to a first end of the output capacitor 36 and through a first terminal of the power converter 3 to a first end (anode terminal) of the LED load 2. A second end of the output capacitor 36 is connected to the second end of the secondary winding S1, the secondary-side ground, and through a second terminal of the power converter 3 to a second end (cathode terminal) of the LED load 2.

The AC power source 31 is a commercial power source that outputs an AC voltage of, for example, 100 V. The diode bridge 32 rectifies positive and negative AC voltages from the AC power source 31 into a positive or negative DC voltage (pulsating voltage) and outputs the DC voltage from the third and fourth terminals thereof. The AC power source 31 and diode bridge 32 that output a DC voltage are replaceable with a DC power source such as a battery. Between the third and fourth (primary-side ground) of the diode bridge 32, a capacitor may be connected. During an ON (conductive) period of the switching element 34, a DC current from the diode bridge 32 passes through the primary winding P and switching element 34. During an OFF (nonconductive) period of the switching element 34, the secondary winding S1 generates a winding voltage (flyback voltage) to supply a DC current from the first end of the secondary winding S1 to the output diode 35, output capacitor 36, and LED load 2.

The controller 4 carries out ON/OFF control of the switching element 34 of the power converter 3, so that the LED load 2 may stably emit light at a predetermined brightness. Based on a feedback signal from the feedback part 5, the controller 4 outputs a control signal to the control terminal of the switching element 34. For this, the controller 4 includes an error amplifier 41, a reference voltage source 42, a capacitor 43, a comparator 44, and a triangle wave generator 45. Together with these elements, the controller 4 may be integrated into a single semiconductor integrated circuit (IC) having at least terminals FB, OUT, and Vcc. Although not illustrated in the drawings nor explained herein, the controller 4 is provided with known protection functions such as an overcurrent protection function and an overvoltage protection function.

The error amplifier 41 has an inverting input terminal (depicted as minus terminal) connected through the terminal FB of the controller 4 to the feedback part 5, a non-inverting input terminal (depicted as plus terminal) connected to a positive electrode of the reference voltage source 42, and an output terminal connected to a non-inverting input terminal of the comparator 44. A negative electrode of the reference voltage source 42 is connected to the primary-side ground. The capacitor 43 is connected between the inverting input terminal and output terminal of the error amplifier 41. An inverting input terminal of the comparator 44 is connected to the triangle wave generator 45 and an output terminal of the comparator 44 is connected through the terminal OUT of the controller 4 to the control terminal of the switching element 34.

The error amplifier 41 amplifies an error between a voltage value of a feedback signal from the feedback part 5 and a voltage value of the reference voltage source 42 and outputs the amplified error as an error signal. The comparator 44 compares a voltage value of the error signal from the error amplifier 41 with a voltage value of a triangle wave signal (sawtooth wave signal) from the triangle wave generator 45, and during a period in which the voltage value of the error signal is greater than the voltage value of the triangle wave signal, outputs a high-level pulse signal as a control signal to the switching element 34. During a period in which the voltage value of the error signal is lower than the voltage value of the triangle wave signal, the comparator 44 outputs a low-level control signal to the switching element 34.

The switching element 34 is ON as the control signal from the comparator 44 of the controller 4 is high level and OFF as the control signal is low level. According to the present embodiment, the controller 4 is a PWM (pulse width modulation) control circuit. As the feedback signal from the feedback part 5 decreases, a duty ratio (ON width) of the control signal increases to extend an ON time of the switching element 34, thereby increasing a voltage across the output capacitor 36. As the feedback signal from the feedback part 5 increases, the duty ratio of the control signal decreases to shorten the ON time of the switching element 34, thereby decreasing the voltage across the output capacitor 36. In this way, the controller 4 according to the first embodiment carries out PWM control of the switching element 34.

The feedback part 5 provides the controller 4 with a feedback signal so that the controller 4 may carry out the ON/OFF control of the switching element 34 according to the feedback signal. For this, the feedback part 5 includes a voltage detector to detect winding voltage information related to a voltage of the tertiary winding S2 and a control information detector to detect control information related to the ON/OFF control of the switching element 34, thereby forming a feedback loop of a constant current control. The feedback part 5 includes a diode 51, a capacitor 52, a zener diode 53, a capacitor 54, a smoothing capacitor 55, and resistors 56, 57, and 58. The zener diode 53 and smoothing capacitor 55 form the control information detector that outputs a control information signal. The resistor 58 operates as the voltage detector that outputs a voltage information signal.

The diode 51 has an anode connected to a first end of the tertiary winding S2 of the transformer 33 and a cathode connected through the resistor 57 to a cathode of the zener diode 53. The tertiary winding S2 is a part of the control power source 6. The capacitor 52 is parasitic capacitance of the diode 51 appearing between the anode and cathode of the diode 51. The zener diode 53 has an anode connected to the primary-side ground and the cathode connected through the resistor 56 to a first end of the smoothing capacitor 55. The zener diode 53 corresponds to the voltage clamper stipulated in the claims and causes a zener breakdown at a voltage value lower than a peak winding voltage value of the tertiary winding S2. The effect of the zener diode 53 will be explained later. The capacitor 54 is parasitic capacitance of the zener diode 53 appearing between the anode and cathode of the zener diode 53.

The smoothing capacitor 55 corresponds to the voltage smoother stipulated in the claims. A first end of the smoothing capacitor 55 is connected to the resistor 58 serving as the voltage detector and through the terminal FB of the controller 4 to the inverting input terminal of the error amplifier 41. A second end of the smoothing capacitor 55 is connected to the primary-side ground. A first end of the resistor 58 is connected to a first end of a smoothing capacitor 62 of the control power source 6 and the terminal Vcc of the controller 4. A second end of the resistor 58 is connected to the first end of the smoothing capacitor 55.

During an OFF period (nonconductive) period of the switching element 34, a winding voltage (flyback voltage) occurs on the tertiary winding S2 of the transformer 33 and is applied to both ends of the zener diode 53. The zener diode 53 causes a zener breakdown at a voltage value lower than a peak value of the winding voltage and clamps the voltage across the zener diode 53. As a result, a pulse voltage waveform appears across the zener diode 53. This pulse voltage waveform is dependent on the zener voltage and an ON/OFF operation of the switching element 34, or is dependent on the zener voltage and an interval to supply power to the LED load 2. The pulse voltage waveform of the zener diode 53 is smoothed by the smoothing capacitor 55 and a voltage across the smoothing capacitor 55 becomes the control information signal whose voltage level changes in response to the duty ratio of a control signal supplied from the controller 4 to the switching element 34, or a period to supply power from the secondary winding S1 to the LED load 2. At this time, the resistor 58 generates a voltage that corresponds to a voltage at the terminal Vcc of the controller 4 and is superposed as the voltage information onto the voltage of the smoothing capacitor 55. The superposed voltages of the smoothing capacitor 55 and resistor 58 is supplied through the terminal FB of the controller 4 to the error amplifier 41 as a feedback signal that is the voltage signal superposed by the control information signal.

The control power source 6 supplies driving power to the controller 4 so that the controller 4 may carry out the ON/OFF control of the switching element 34. The control power source 6 includes the tertiary winding S2 and a rectifying-smoothing part that includes a diode 61 and the smoothing capacitor 62.

The tertiary winding S2 is wound around the core of the transformer 33 in an opposite polarity with respect to the polarity of the primary winding P. The first end of the tertiary winding S2 is connected to the anodes of the diodes 51 and 61 and a second end thereof is connected to the primary-side ground. A cathode of the diode 61 is connected to the first end of the smoothing capacitor 62, the terminal Vcc of the controller 4, and the first end of the resistor 58 of the feedback part 5. A second end of the smoothing capacitor 62 is connected to the second end of the tertiary winding S2 and the primary-side ground.

During an OFT (nonconductive) period of the switching element 34, a winding voltage occurs on the tertiary winding S2 as mentioned above and charges the smoothing capacitor 62 through the diode 61. The voltage of the smoothing capacitor 62 is supplied as a controlled power source through the terminal Vcc to each element in the controller 4.

Operation of the LED driver 1 in the LED illuminator 100 according to the first embodiment will be explained. FIG. 3 is a graph illustrating VF-ILED (forward voltage-LED current) characteristic curves of the first embodiment, related art, and first and second reference examples. In FIG. 3, an X-axis indicates a forward voltage VF of an LED load and Y-axis indicates an LED current ILED to the LED load.

The VF-ILED characteristic curves of the LED drivers according to the first embodiment, related art, and first and second reference examples illustrated in FIG. 3 are obtained with AC 100 V supplied to the LED drivers. The forward voltage VF of each of the LED loads that individually receive currents from the LED drivers is changed within the range of plus-minus 20% around a median value (100%), and at each forward voltage, a steady-state ILED value is measured. The forward voltage VF of the LED load 2 in, for example, the LED driver 1 of the first embodiment is the sum of forward voltages of the LEDs 2-1 to 2-n. The LED current ILED is expressed in percentage with respect to a reference current value (100%) that is measured when the forward voltage VF of the LED load is at the median value.

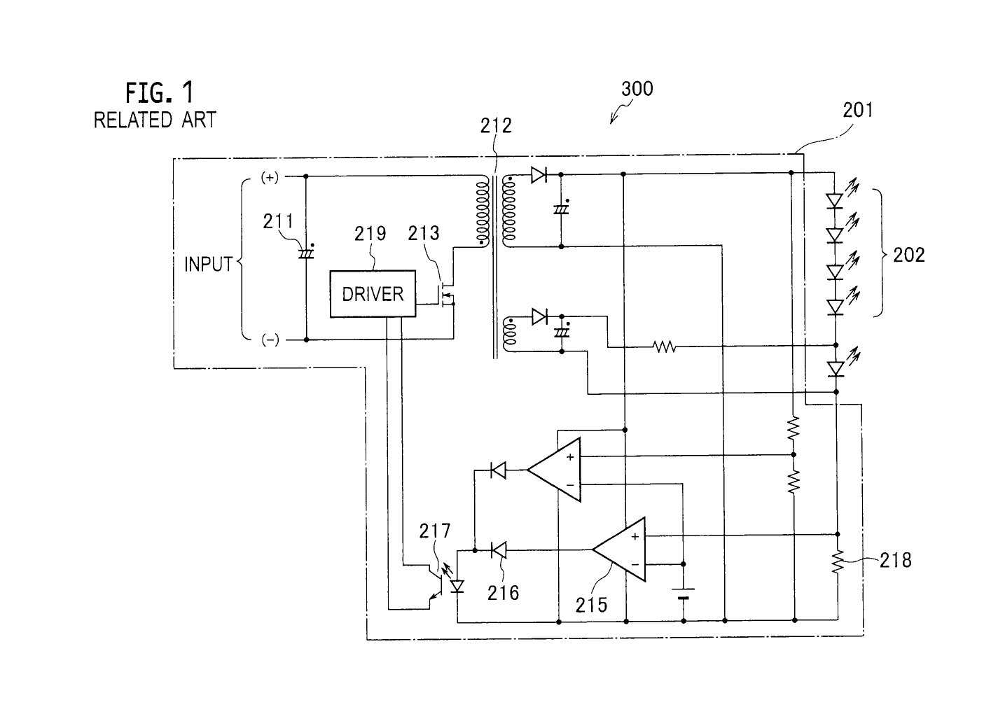

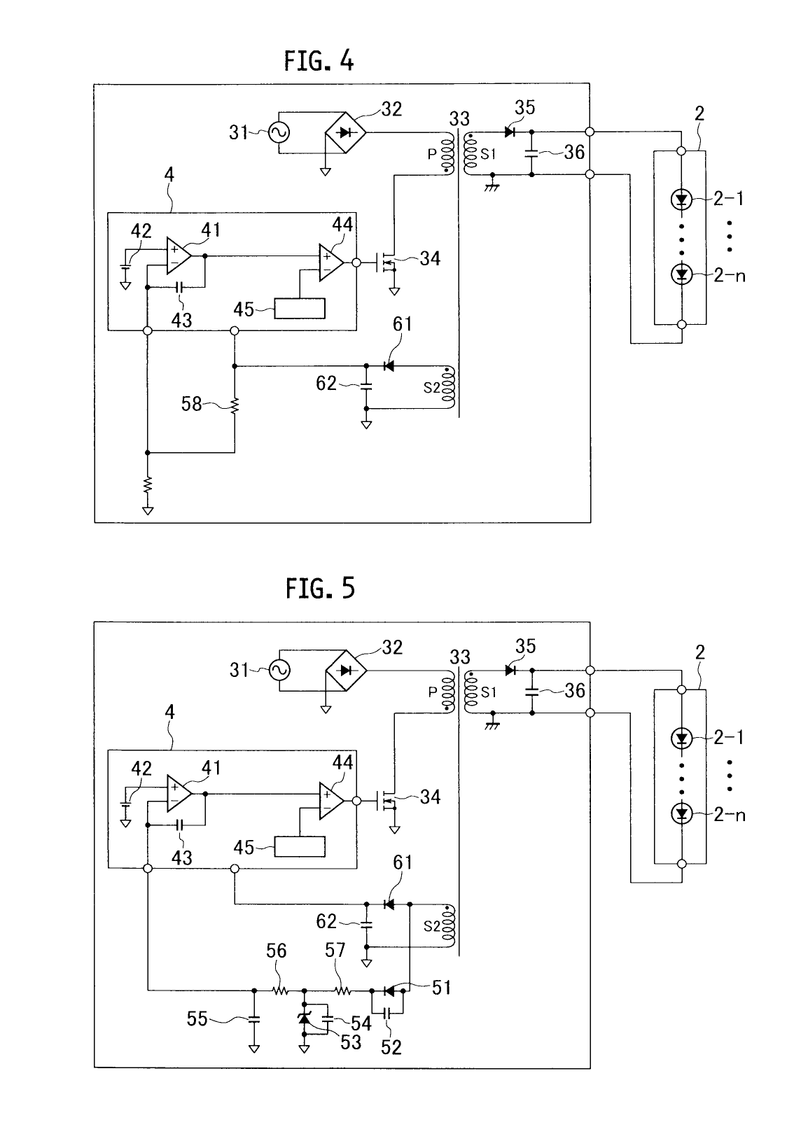

In FIG. 3, a continuous line A is the VF-ILED characteristic curve of the LED driver 1 according to the first embodiment, a dotted line B is that of the LED driver according to the related art of FIG. 1, and a dotted line C is that of the LED driver according to the first comparative example illustrated in FIG. 4. The first comparative example of FIG. 4 detects only winding voltage information on the tertiary winding S2, and therefore, is not provided with the control information detector including the zener diode 53 and smoothing capacitor 55 of the first embodiment. A dotted line D of FIG. 3 is the VF-ILED characteristic curve of the LED driver according to the second comparative example illustrated in FIG. 5. The second comparative example of FIG. 5 detects only control information on the tertiary winding S2, and therefore, is not provided with the voltage detector including the resistor 58 of the first embodiment.

The LED driver of the related art of the dotted line B directly detects an LED current, and based on the detected LED current, carries out constant current control. Due to this, a variation in the LED current ILED with respect to a variation in the forward voltage VF is minimum and the LED current ILED is substantially equal to the reference value (100%) even when the forward voltage VF varies to 80% to 120% around the median value. The LED driver of the first reference example of the dotted line C causes a large deviation in the LED current ILED with respect to a small variation in the forward voltage VF. Namely, the first reference example causes, with respect to a variation of several percentages around the median value in the forward voltage VF, a variation of 10% to 250% around the reference value in the LED current ILED. Compared to the first reference example, the second reference example of the dotted line D reduces variations in the LED current ILED with respect to variations in the forward voltage VF. Namely, the second reference example causes, when the forward voltage VF varies to 90% or 110% from the median value (100%), a variation of about 90% to 110% from the reference value in the LED current ILED.

The LED driver 1 of the first embodiment of the continuous line A carries out constant current control according to alternative characteristics that substitute for the LED current ILED, and therefore, a variation in the LED current ILED with respect to a variation in the forward voltage VF according to the first embodiment tends to be greater than that according to the related art. More precisely, the first embodiment demonstrates about a 97% ILED value with respect to an 80% VF value, about a 92% ILED value with respect to a 120% VF value, about a 100% ILED value (reference value) with respect to a 90% VF value, and about a 97% ILED value with respect to a 110% VF value. In this way, the LED driver 1 in the LED illuminator 100 according to the first embodiment sufficiently meets a practical accuracy requirement for general illumination use.

The LED driver 1 and LED illuminator 100 according to the first embodiment of the present invention provide effects mentioned below.

(1) The LED driver 1 controls DC power supplied to the LED load 2 according to, instead of an LED current, a winding voltage generated at the tertiary winding S2 of the transformer 33 and control information obtained from this winding voltage, thereby supplying a constant current to the LED load 2.

(2) The LED driver 1 stably controls an LED current with respect to a variation in a forward voltage of the LED load 2, thereby preventing the LED load 2 of the LED illuminator 100 from flickering.

(3) The feedback part 5 as a constant current control feedback loop is connected to the primary side of the transformer 33 to eliminate an insulated signal transmission element such as a photocoupler, thereby reducing the sizes and costs of the LED driver 1 and LED illuminator 100.

(4) The feedback part 5 and controller 4 are connected to the primary side of the transformer 33, thereby increasing a response speed of the controller 4 with respect to a feedback signal from the feedback part 5 and improving controllability of an LED current.

(5) By lowering the resistance value of the resistor 58 so as to increase the influence of the winding voltage signal on the feedback signal, the LED driver 1 according to the first embodiment can supply constant power to the LED load 2.

### Second Embodiment

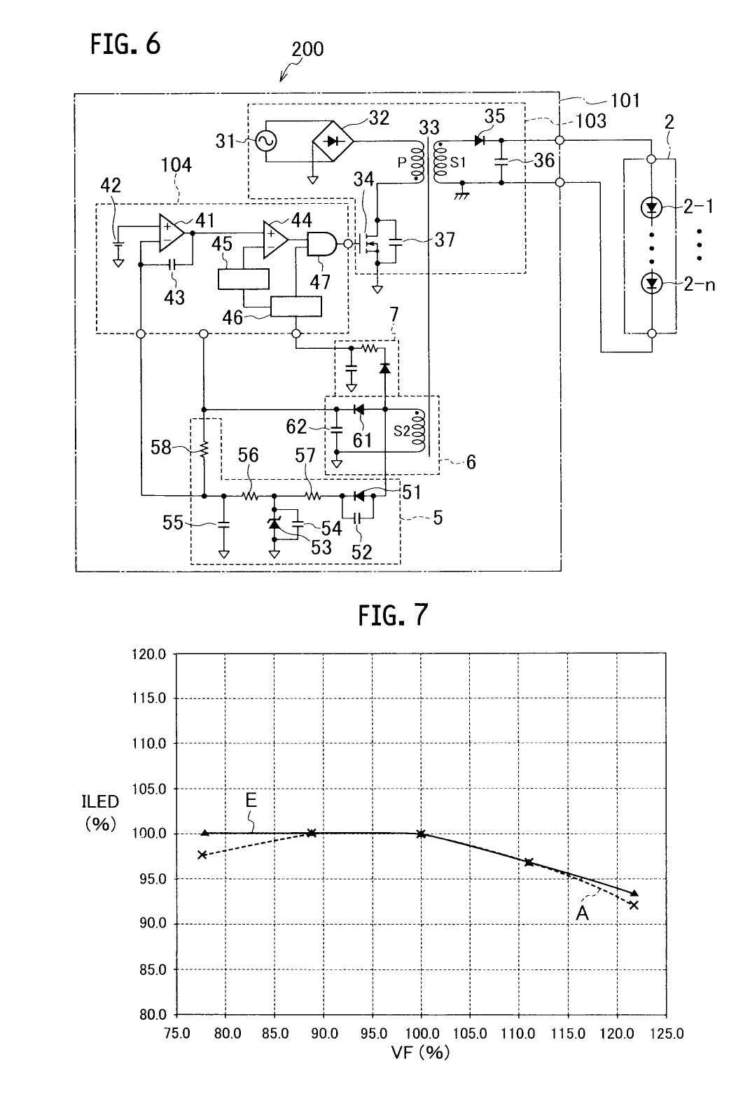

FIG. 6 is a circuit diagram illustrating an LED driver and LED illuminator according to the second embodiment of the present invention. The LED illuminator 200 according to the second embodiment includes the LED driver 101 and an LED load 2 connected to the LED driver 101.

The LED driver 101 includes an insulated power converter 103 connected to the LED load 2, a controller 104 connected to the power converter 103, and a feedback part 5 connected to the power converter 103 and controller 104. The LED driver 101 also includes a control power source 6 connected to the controller 104 and feedback part 5 and a resonance signal detector 7 connected to the control power source 6.

The second embodiment differs from the first embodiment in that the power converter 103 of the second embodiment is a known quasi-resonance flyback converter and the controller 104 of the second embodiment controls the power converter 103 according to a voltage resonance signal provided by the resonance signal detector 7. Except these differences, the second embodiment is substantially the same as the first embodiment, and therefore, only the differences will be explained in detail.

The power converter 103 allows a voltage across a switching element 34 to freely oscillate during an OFF period of the switching element 34. For this, the power converter 103 employs a resonance capacitor 37 connected in parallel with the switching element 34, so that the resonance capacitor 37 and a primary winding P of a transformer 33 may resonate in an OFF period of the switching element 34. The resonance signal detector 7 detects winding voltage information on a tertiary winding S2 of the transformer 33 in an OFF period of the switching element 34 and outputs the detected information as a voltage resonance signal to the controller 104. The resonance signal detector 7 is connected to the control power source 6 and controller 104 and is configured to rectify and smooth a winding voltage of the tertiary winding S2. According to the voltage resonance signal from the resonance signal detector 7 and a control information signal from the feedback part 5, the controller 104 carries out ON/OFF control of the switching element 34. For this, the controller 104 includes a control determination part 46 and an AND gate 47.

The control determination part 46 is connected to the resonance signal detector 7, a triangle wave generator 45, and the AND gate 47. The control determination part 46 determines a voltage level of the voltage resonance signal, and according to a result of the determination, controls oscillation of the triangle wave generator 45 and through the AND gate 47 operation of the switching element 34. When the winding voltage of the tertiary winding S2 decreases to decrease the voltage level of the voltage resonance signal lower than a predetermined value, the control determination part 46 outputs a high-level determination signal. If the voltage level of the voltage resonance signal is higher than the predetermined value, the control determination part 46 outputs a low-level determination signal. The AND gate 47 has a first input terminal connected to an output terminal of a comparator 44, a second input terminal connected to the control determination part 46, and an output terminal connected to a control terminal (gate) of the switching element 34. If an output signal from the comparator 44 and the determination signal from the control determination part 46 each are high, the AND gate 47 turns on the switching element 34. If the determination signal from the control determination part 46 is high, the triangle wave generator 45 oscillates to generate a triangle wave signal.

Due to a characteristic of the quasi-resonance flyback converter, the control information signal from the feedback part 5 in the LED driver 101 according to the second embodiment changes its voltage level according to the duty ratio and frequency of a control signal supplied from the controller 104 to the switching element 34, or a period to supply power to the LED load 2.

FIG. 7 is a graph illustrating VF-ILED (forward voltage-LED current) characteristic curves of the LED driver 101 and LED illuminator 200 according to the second embodiment and the LED driver 1 and LED illuminator 100 according to the first embodiment.

In FIG. 7, a continuous line E is of the second embodiment and a dotted line A is of the first embodiment and corresponds to the continuous line A of FIG. 3. As indicated with the continuous line E, the second embodiment demonstrates a good current control characteristic like the first embodiment of the line A. Accordingly, the LED driver 101 of the second embodiment sufficiently meets a practical accuracy requirement for general illumination use.

The second embodiment provides the same effects as the first embodiment.

### Third Embodiment

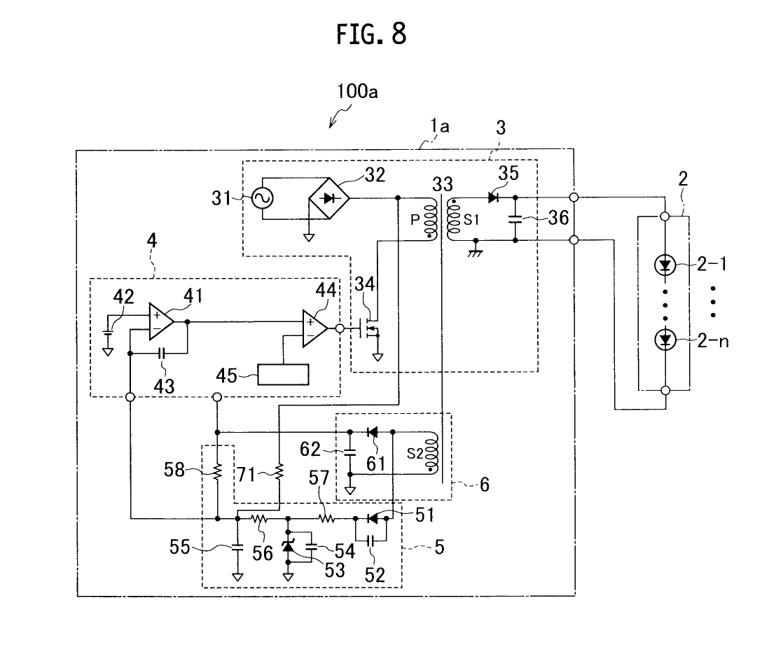

FIG. 8 is a circuit diagram illustrating an LED driver and

LED illuminator according to the third embodiment of the present invention. The LED illuminator 100a according to the third embodiment includes the LED driver 1a and an LED load 2 connected to the LED driver 1a.

The LED driver 1a according to the third embodiment includes a resistor 71 in addition to the configuration of the LED driver 1 according to the first embodiment illustrated in FIG. 2. The resistor 71 is an AC input correcting resistor having a first end connected to a first end of a primary winding P of a transformer 33 and an output terminal of a diode bridge 32 and a second end connected to first ends of resistors 56 and 58 and a first end of a capacitor 55.

If a forward voltage VF of the LED load 2 increases, an operation of widening an ON pulse width of a control signal to be supplied from a controller 4 to a switching element 34 must be superposed onto a feedback signal to be supplied from a feedback part 5 to the controller 4. Since the voltage of a tertiary winding (auxiliary winding) S2 of the transformer 33 increases as the forward voltage VF increases, the forward voltage variation correcting resistor 58 detects a rectified-smoothed voltage of the tertiary winding S2 and outputs the detected voltage as a forward voltage variation correcting voltage signal to an error amplifier 41. As a result, if the voltage of the tertiary winding S2 increases, the ON pulse width of the switching element 34 in a power converter 3 is widened, to realize a constant current characteristic even if the forward voltage VF varies.

If AC input widely varies, the voltage of the tertiary winding S2 alone is insufficient to control the duty ratio of the switching element 34 to realize the constant current characteristic. To solve this problem, the third embodiment employs the AC input correcting resistor 71 to detect an AC input voltage at a connection point between the output terminal of the diode bridge 32 and the first end of the primary winding P of the transformer 33 and output the detected voltage as an AC input correcting voltage signal to the error amplifier 41.

Even if the forward voltage VF varies or AC input widely changes, the LED driver 1a according to the third embodiment realizes a practically satisfactory constant current characteristic with the use of the resistor 58 for forward voltage variation correction and the resistor 71 for AC input variation correction. In realizing the constant current characteristic, the third embodiment needs no constant current circuit including a current detecting resistor and an operational amplifier, or a photocoupler for transmitting a feedback signal. Accordingly, the LED driver 1a and LED illuminator 100a according to the third embodiment are manufacturable at low cost. The power converter 3 is not limited to that of a flyback type. It may be of a forward type.

### Fourth Embodiment

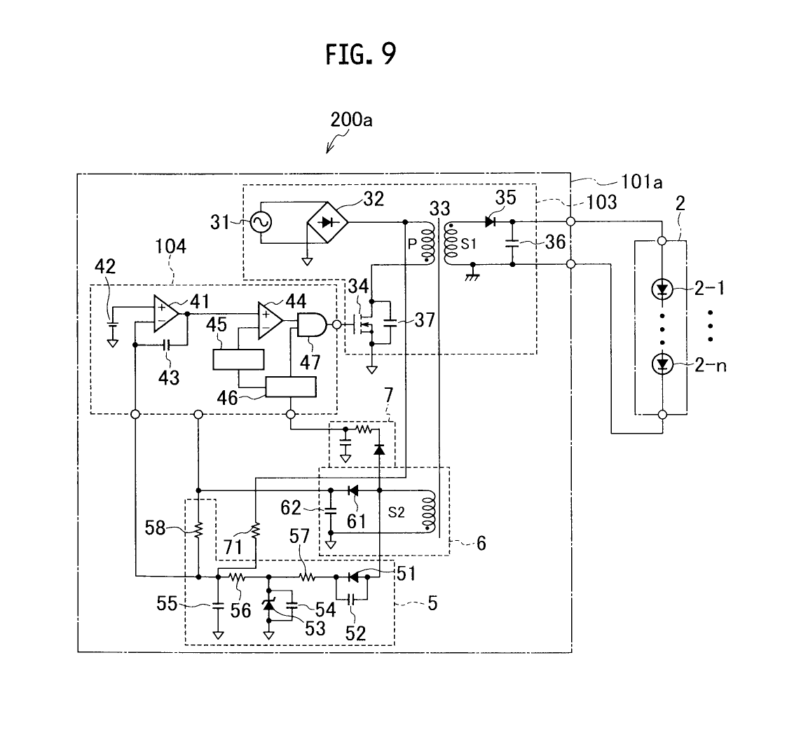

FIG. 9 is a circuit diagram illustrating an LED driver and LED illuminator according to the fourth embodiment of the present invention. The LED illuminator 200a of the fourth embodiment includes the LED driver 101a and an LED load 2 connected to the LED driver 101a.

The LED driver 101a includes a resistor 71 in addition to the configuration of the LED driver 101 of the second embodiment illustrated in FIG. 6. The resistor 71 is an AC input correcting resistor having a first end connected to a first end of a primary winding P of a transformer 33 and an output terminal of a diode bridge 32 and a second end connected to first ends of resistors 56 and 58 and a first end of a capacitor 55.

The LED driver 101a according to the fourth embodiment provides the same effects as the LED driver 101 according to the second embodiment. In addition, the fourth embodiment uses the AC input correcting resistor 71 to properly correct AC input power even if the AC input power widely varies, thereby realizing a practically satisfactory constant current characteristic. In realizing the constant current characteristic, the fourth embodiment needs no constant current circuit including a current detecting resistor and an operational amplifier, or a photocoupler for transmitting a feedback signal. Accordingly, the LED driver 101a and LED illuminator 200a according to the fourth embodiment are manufacturable at low cost.

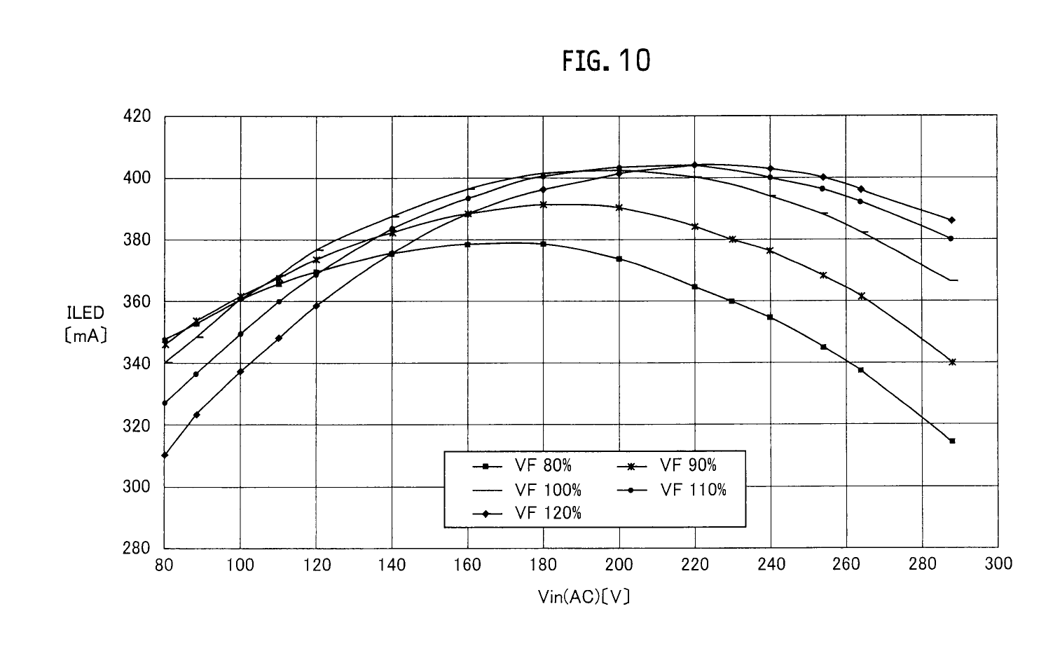

FIG. 10 is a graph illustrating Vin-ILED (AC input voltage-LED current) characteristic curves of the LED driver 101a according to the fourth embodiment of the present invention. In FIG. 10, Vin is an AC input voltage and ILED is a current passing through the LED load 2. With a forward voltage VF of the LED load 2 being set to a median value (VF 100%) and to other values within the range of plus-minus 20% around the median value, the AC input voltage Vin is changed to measure the load current ILED. It is understood from FIG. 10 that, when the AC input voltage changes in the range of AC 100 V plus-minus 10% to AC 230V plus-minus 20%, the load current ILED varies from 323 mAmin to 360 mAtyp to 404 mAmax, i.e., from −10% to +12% around the typical value of 360 mAtyp.

### Fifth Embodiment

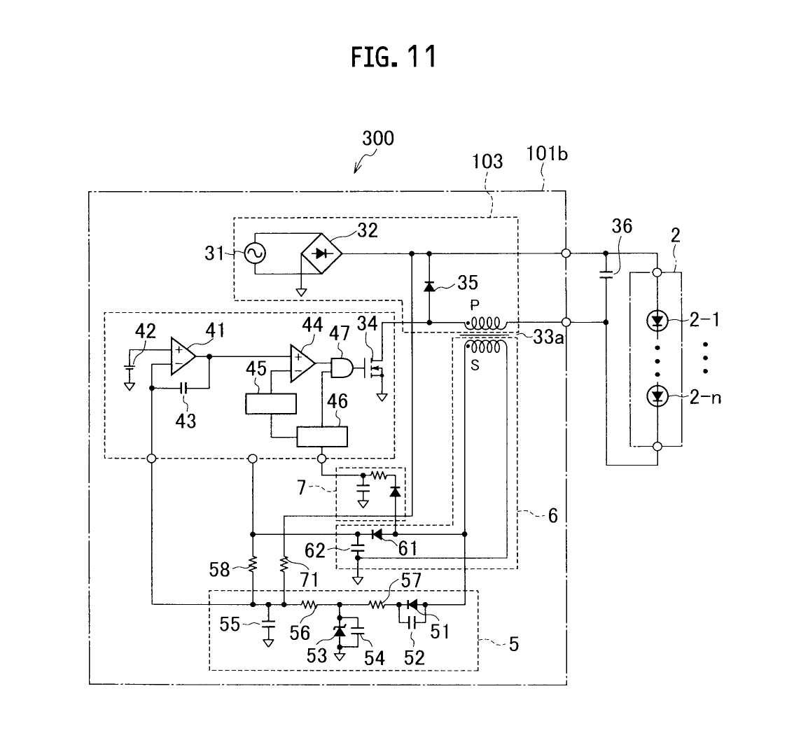

FIG. 11 is a circuit diagram illustrating an LED driver and LED illuminator according to the fifth embodiment of the present invention. The LED driver 101b according to the fifth embodiment is of a step-up chopper type involving a transformer 33a having a primary winding P and a secondary winding S, a diode 35, and a capacitor 36.

A cathode of the diode 35 is connected to an output terminal of a diode bridge 32, a first end of the capacitor 36, and a first end of an LED load 2. An anode of the diode 35 is connected through the primary winding P to a second end of the capacitor 36. Both ends of the capacitor 36 are connected to both ends of the LED load 2, respectively.

A first end of the secondary winding S of the transformer 33a is connected to an anode of a diode 61, an anode of a diode of a rectifying-smoothing circuit 7, an anode of a diode 51, and a first end of a capacitor 52. A second end of the secondary winding S is connected to a first end of a capacitor 62.

The remaining configuration of the LED driver 101b of FIG. 11 is the same as the LED driver 101a of the fourth embodiment illustrated in FIG. 9, and therefore, the same parts are represented with the same reference marks to omit overlapping explanations.

Operation of the LED driver 101b according to the fifth embodiment will be explained. When a switching element 34 is turned on, a current passes through a path extending along the diode bridge 32, LED load 2, primary winding P, and switching element 34, to make LED load 2 emit light.

When the switching element 34 is turned off, a current passes through a path extending along the primary winding P, diode 35, LED load 2, and primary winding P, to make the LED load 2 emit light.

According to the fifth embodiment, a winding voltage of the secondary winding S of the transformer 33a is supplied to a resistor 58 through the diode 61 and also to a parallel circuit including the diode 51 and capacitor 52. An AC input voltage from the diode bridge 32 is supplied to a resistor 71.

Accordingly, like the first to fourth embodiments, the fifth embodiment carries out a forward voltage variation correction with the resistor 58 and an AC input correction with the resistor 71, to realize a practically satisfactory constant current characteristic. In realizing the constant current feature, the fifth embodiment needs no constant current circuit including a current detecting resistor and an operational amplifier as an error amplifier, or a photocoupler for transmitting a feedback signal. Accordingly, the LED driver 101b and LED illuminator 300 according to the fifth embodiment are manufacturable at low cost. Although the LED driver 101b according to the fifth embodiment operates in a critical mode (quasi-resonance mode), the present invention is also applicable a PWM system.

### Sixth Embodiment

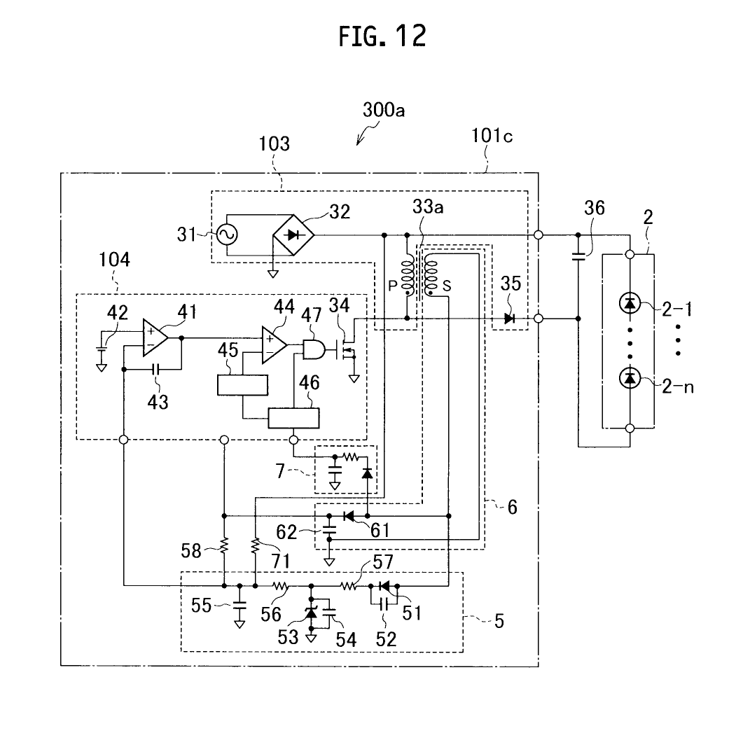

FIG. 12 is a circuit diagram illustrating an LED driver and LED illuminator according to the sixth embodiment of the present invention. The LED driver 101c according to the sixth embodiment is of an inverting chopper type involving a transformer 33a having a primary winding P and a secondary winding S, a diode 35, and a capacitor 36. Differences of the sixth embodiment from the fifth embodiment illustrated in FIG. 11 will be explained.

A first end of the primary winding P of the transformer 33a is connected to an output terminal of a diode bridge 32 and a first end of the capacitor 36 and a second end of the primary winding P is connected to a first end of a switching element 34 and an anode of the diode 35. A cathode of the diode 35 is connected to a second end of the capacitor 36. Both ends of the capacitor 36 are connected to both ends of an LED load 2, respectively. The polarity of the LED load 2 is opposite to the polarity of the LED load 2 of the fifth embodiment.

Operation of the LED driver 101c according to the sixth embodiment will be explained. When the switching element 34 is turned on, a current passes through a path extending along the diode bridge 32, primary winding P, and switching element 34.

When the switching element 34 is turned off, a current passes through a path extending along the primary winding P, diode 35, LED load 2, and primary winding P, to make the LED load 2 emit light.

According to the sixth embodiment, a winding voltage of the secondary winding S of the transformer 33a is supplied to a resistor 58 through a diode 61 and also to a parallel circuit including a diode 51 and capacitor 52. An AC input voltage from the diode bridge 32 is supplied to a resistor 71.

Accordingly, like the first to fourth embodiments, the sixth embodiment carries out a forward voltage variation correction with the resistor 58 and an AC input correction with the resistor 71, to realize a practically satisfactory constant current characteristic. In realizing the constant current feature, the sixth embodiment needs no constant current circuit including a current detecting resistor and an operational amplifier as an error amplifier, or a photocoupler for transmitting a feedback signal. Accordingly, the LED driver 101c and LED illuminator 300a according to the sixth embodiment are manufacturable at low cost. Although the LED driver 101c according to the sixth embodiment operates in a critical mode (quasi-resonance mode), the present invention is also applicable to a PWM system.

The configurations, shapes, sizes, and arrangements of components adopted by the above-mentioned embodiments are only examples to explain the present invention in understandable and executable manners. These embodiments are not intended to limit the present invention and are modifiable in various ways without departing from the scope of the present invention.

For example, the controller 4 (104) and switching element 34 may be integrated into a single IC, or the controller 4 (104) and feedback part 5 may be integrated into a single IC. According to the embodiments, the transformer 33 has primary, secondary, and tertiary windings. Instead, the transformer may have higher order n of windings, where n is a natural number equal to or greater than 3.

In summary, the LED driver provided by the present invention employs the feedback unit that is connected to a secondary winding of a transformer and generates a feedback signal by superposing control information related to ON/OFF control of a switching element onto winding voltage information related to a voltage of the secondary winding and the control unit that turns on/off the switching element according to the feedback signal so that a constant current is supplied to an LED load. With this configuration, the LED driver and the LED illuminator incorporating the LED driver are compact and low-cost.

This application claims benefit of priority under 35 USC §119 to Japanese Patent Applications No. 2011-076139, filed on Mar. 30, 2011 and No. 2011-287910, filed on Dec. 28, 2011, the entire contents of which are incorporated by reference herein.

What is claimed is:

1. An LED driver comprising:
a power converter including a transformer with a primary winding and a secondary winding and a switching element connected to the primary winding and supplying power through the primary winding to an LED load;
a feedback part connected to the secondary winding and including a control information detector configured to detect control information related to ON/OFF control of the switching element and a voltage detector configured to detect winding voltage information related to a voltage of the secondary winding; and
a controller carrying out the ON/OFF control of the switching element, wherein:
the feedback part generates a feedback signal by superposing the control information onto the winding voltage information; and
the controller carries out the ON/OFF control of the switching element according to the feedback signal.

2. The LED driver of claim 1, wherein
the control information detector detects at least one of a duty ratio of the ON/OFF control and a period during which power is supplied through the primary winding to the LED load as the control information.

3. The LED driver of claim 1, wherein
the control information detector detects a control frequency of the ON/OFF control as the control information.

4. The LED driver of claim 1, wherein
the control information detector includes a voltage clamper clamping a winding voltage of the secondary winding and a voltage smoother connected in parallel with the voltage clamp and smoothing the clamped winding voltage.

5. The LED driver of claim 1, further comprising
a control power source connected between the secondary winding and the controller.

6. The LED driver of claim 1, wherein
the feedback unit provides the feedback signal by superposing the control information, the winding voltage information, and AC input voltage information onto one another.

7. An LED illuminator comprising:
an LED load including at least one LED; and
the LED driver according to claim 1.
